(19) United States
(12) Patent Application Publication
(10) Pub. No.: US 2019/0205866 A1
(43) Pub. Date: Jul. 4, 2019

(54) MOBILE WALLET WITH UNLOCKABLE CAPABILITIES IN A GAMING SYSTEM

(71) Applicant: IGT, Las Vegas, NV (US)

(72) Inventors: Kevin HIGGINS, Reno, NV (US); Jeffery SHEPHERD, Reno, NV (US)

(73) Assignee: IGT, Las Vegas, NV (US)

(21) Appl. No.: 15/859,556

(22) Filed: Dec. 31, 2017

(51) Int. Cl. G06Q 20/36; G06Q 20/10; G07F 17/32

(52) U.S. Cl. CPC G06Q 20/36; G06Q 20/10; G06Q 20/3825; G07F 17/3225; G07F 17/3241; G07F 17/3244

(57) ABSTRACT

Technology for providing tiered mobile wallet capabilities in a gaming system is disclosed. A portable electronic device may execute a gaming establishment application, the gaming establishment application storing virtual account information of a player and providing monetary transfer operations to at least one payment system within a gaming establishment. The portable electronic device may lock and unlock at least a portion of the virtual account information and the monetary transfer operations within the gaming establishment application such that, upon locking at least the portion of the virtual account information and the monetary transfer operations, at least one of the monetary transfer operations to the at least one payment system within the gaming establishment is disabled.

### BACKGROUND

The present disclosure relates in general to gaming devices and systems, and more particularly to managing mobile wallet functionality in a gaming system.

Games of chance have been enjoyed by people for many years and have undergone increased and widespread popularity in recent times. As with most forms of entertainment, some players enjoy playing a single favorite game, while others prefer playing a wide variety of games. In response to the diverse range of player preferences, gaming establishments commonly offer many types of electronic games. Many electronic gaming machines (EGMs), such as slot machines and video poker machines, have been a cornerstone of the gaming industry for several years. The EGMs include specially programmed computers and contain multiple external interfaces. Further, the EGMs, or the gaming establishments themselves, may provide mobile services such as funds transferring and game functionality within the gaming establishments to mobile or “player” devices through various applications deployed on the mobile devices which the player may use to more efficiently facilitate gameplay, purchase goods and services, and a variety of other functions.

### BRIEF SUMMARY

Various embodiments for providing tiered mobile wallet capabilities in a gaming system are disclosed. A portable electronic device may execute a gaming establishment application, the gaming establishment application storing virtual account information of a player and providing monetary transfer operations to at least one payment system within a gaming establishment. The portable electronic device may lock and unlock at least a portion of the virtual account information and the monetary transfer operations within the gaming establishment application such that, upon locking at least the portion of the virtual account information and the monetary transfer operations, at least one of the monetary transfer operations to the at least one payment system within the gaming establishment is disabled.

The foregoing summary has been provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Aspects of the present disclosure are illustrated by way of example and are not limited by the accompanying drawings:

FIG. 1 is a block diagram illustrating a gaming system environment with a gaming terminal data repository (GTDR) connected via one or more network interface(s) to a gaming network which, for example, may include gaming devices (e.g., gaming terminals);

FIG. 2 is a perspective view of one embodiment of a slot machine or gaming device suitable for use in the gaming system of FIG. 1;

FIG. 3 is a block diagram illustrating an electronic configuration for use in the gaming device of FIG. 2;

FIG. 4 is a block diagram illustrating communications between a portable electronic device and multiple payment systems within a gaming establishment;

FIG. 5 is a flowchart illustrating an exemplary method for providing tiered mobile wallet capabilities in a gaming system;

FIG. 6 is a block diagram illustrating a gaming establishment application for use on the portable electronic device; and

FIG. 7 is a flowchart illustrating an additional exemplary method for providing tiered mobile wallet capabilities in a gaming system.

### DETAILED DESCRIPTION

A gaming system (i.e., an EGM) may offer a variety of services or functions such as, for example, functionality for transferring money, providing gameplay for games of chance, ordering promotions or services, or even an interface for a user to interact with social media. By extension, the EGM may also facilitate providing these and other services or functions to mobile devices or “portable electronic devices” used within and/or externally to a gaming establishment in which the EGM is located.

An ever increasing portion of patrons who visit gaming establishments (i.e., casinos) are regularly carrying these portable electronic devices, such as smart phones, laptops, netbooks and tablet computers capable of wireless communications, on their person. The portable electronic devices provide 1) a means of communication allowing the patron to communicate with other individuals within or outside of a casino via a number of different communication modes, 2) a source of news and information, 3) a portal to the patron's on-line activities, such as social media applications, 4) support for entertainment features, such as audio/video playback and gaming applications, 5) a repository for personal information, such as financial information that enables financial transactions in mobile wallet applications and 6) a means of capturing information, such as video images and audio recordings. Thus, portable electronic devices, such as smart phones, are becoming essential tools and, in some instances, the primary electronic interface for many individuals. The popularity of portable electronic devices allows for the possibility of utilizing their capabilities to further personalize and enhance the gaming experience in a casino gaming environment.

With this proliferation of portable electronic devices comes an inherent expectation by the player that the data (e.g., financial data, personal data, etc.) stored within applications executing on the portable electronic device will be kept secure. Further, the gaming establishments, regulatory (governing) bodies, and the player's themselves may impose or expect to impose certain restrictions on how the data, such as financial data, stored on the portable electronic device is accessed and used within the gaming establishment.

Thus, the present disclosure details embodiments to provide mobile wallet functionality through the use of portable electronic devices, while controlling access restrictions to certain portions of the capabilities thereof and the data stored therein. For example, the portable electronic device may execute what will be referred to herein as a “gaming establishment application”. This generally comprises a first-party application (one developed and distributed by the gaming establishment itself) which a player may download onto their portable electronic device to facilitate communicating with gaming machines and other devices in the gaming establishment. The gaming establishment application may include, at least as part of the functionality provided therein, mobile wallet mechanisms which store financial data (e.g., non-monetary credit balance information held by the player and issued by the gaming establishment, banking information, credit card information, etc.) allowing the player to fund an account balance with the gaming establishment (e.g., by deducting funds from their external bank account for deposit into the account balance of the mobile wallet), and which allow a player to complete cashless and wireless purchases using their portable electronic device at various payment systems across the gaming establishment using the financial data (such as their mobile wallet account balance) stored in the gaming establishment application.

These payment systems of the gaming establishment may include payment systems incorporated into wagering games (i.e., electronic gaming machines (EGMs)), payment systems at one or more stores or gift shops within the gaming establishment, payment systems for purchasing shows or other entertainment, etc. For example, Bluetooth™ and Wi-Fi™ can be used to wirelessly pair a portable device with an EGM. Near field communication (NFC) pairing can also be used to wirelessly connect an EGM with the portable electronic device for facilitating transactions, data exchange, and other wireless communications between the two devices when they are in close proximity to each other, usually about a few centimeters. NFC chips embedded in the portable electronic device can be used to store information, in addition or in conjunction with the player's mobile wallet account, such as credit card data belonging to the owner of the portable electronic device. When the patron waves or holds his or her portable electronic device near the EGM, or the portable electronic device is simply near the EGM, the portable electronic device can send such information to the EGM so that the EGM can identify the patron and fund gameplay of the EGM.

Moreover, the portable electronic device may use similar communications protocols and methods to fund, via the mobile wallet, transactions completed at the aforementioned payment systems of gift or merchandise shops, restaurants, and other various stores located at the gaming establishment. Further, the same mobile wallet and associated gaming establishment application may be used to purchase other goods and services via similar communications protocols with additional payment systems in the gaming establishment (e.g., hotel expenses purchased at a front desk, shows or other forms of entertainment purchased at a ticket booth, etc.), or these purchases may be conducted “in-app” such that the services are rendered in a virtual form (e.g., a virtual ticket is created for a show within the gaming establishment application and the funding for such deducted from the player's mobile wallet account). Indeed, the gaming establishment application and its associated mobile wallet functionality may serve as a “gateway” to all games and rendered goods and services within the scope of the gaming establishment.

Therefore, with such a wide range of functionality provided by the gaming establishment application and the mobile wallet mechanisms therein, the present disclosure provides techniques for controlling access to which portions or capabilities of the mobile wallet are allowed to interact with which parts of the gaming establishment. Further, the functionality disclosed herein allows access control to what data (financial, personal, and otherwise) the player and the gaming establishment is able to observe.

### Gaming Systems in a Gaming Environment

By way of background, but not by way of limitation, the following describes a representative computer environment in which the techniques of this disclosure (described below) may be practiced.

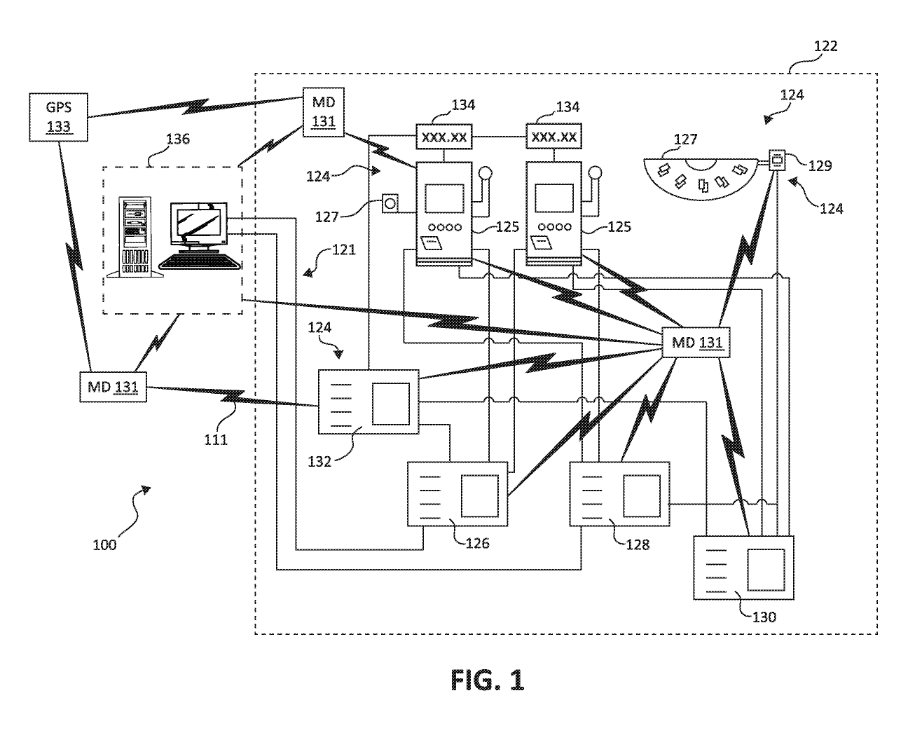

Turning now to FIG. 1, a block diagram illustrating a gaming system environment 100 is shown. Environment 100 includes a Gaming Terminal Data Repository (GTDR) connected via one or more network interface(s) to a gaming network which, for example, may include gaming devices (e.g., gaming terminals) and/or other devices, in which aspects of the present disclosure may be realized. As illustrated in FIG. 1, the gaming environment 100 may comprise a gaming system/environment 122 located in a physical environment (not shown). It will be appreciated that the communication links between the various components may be separate and distinct or may be commonly used. It will also be appreciated that one or more of the functions or applications described above may be consolidated, such as at a common server or host. Further, other components for implementing other functionality may be provided. For example, a variety of computing devices, such as user stations, may be connected to the various systems. Printers and other peripheral devices may also be connected to each network or system. A gaming system/environment 122 (e.g., the gaming establishment) may be located at least partially in one or more physical gaming environments, such as a casino, restaurant, and/or convenience store. For example, the casino may include publicly accessible game areas where certain of the gaming system devices 124, such as gaming machines 125 and table games 127 are located, as well as secure areas where the servers and other components are located.

In one embodiment, the physical environment includes at least a portion of a physical structure, such as the gaming establishment or casino, housing one or more components of the gaming system/environment 122. The gaming system/environment 122 includes one or more gaming system devices 124 or components. The gaming system devices 124 may include gaming machines 125, such as those known as video or slot machines. The gaming system devices 124 may also include “table” games 127 such as Blackjack and Roulette. The gaming system devices 124 may also include components or devices such as player tracking card readers 129, coin counters and other gaming device functionality options, which devices or components may be linked or associated with other devices. The devices or components may also comprise computers or servers and communication equipment, cashier and accounting workstations and a wide variety of other elements.

In one embodiment, the gaming system/environment 122 may include a variety of sub-systems. These sub-systems may be partially or fully independent of one another or may be related. In one embodiment, each system may be included or be part of a network. In one embodiment, the gaming system/environment 122 may include a game presentation/operation system, which includes at least one game server 126. The game server 126 may comprise a computing device including a processor and a memory. The game server 126 may be adapted to perform a variety of functions. This functionality may be implemented by software and/or hardware of the server 126. In one embodiment, the game server 126 may be arranged to provide information or instructions to the one or more gaming devices 124 or individual gaming system components. The information may comprise game code and control data. In one embodiment, the game server 126 may also be arranged to accept information from the gaming devices 124 or components. For example, the game server 126 may accept information regarding the status of operation of a particular gaming system device 124 (such as “normal” or “malfunction”).

In one embodiment, the game server 126 is part of a network, which includes a communication link between the game server 126 and selected gaming system device(s) 124 and/or other component(s) with which communication is desired. A communication interface may be associated with the game server 126 and each device or component for facilitating the communication. The communication interfaces may have a variety of architectures and utilize a variety of protocols such as IEEE-1394 (FireWire™) or Ethernet in the case where the communication link is a wired link, or a wireless link utilizing a wireless protocol such as WIFI, Bluetooth™, Radio Frequency (RF), Infrared, third generation partnership project (3GPP) long term evolution (LTE), Worldwide interoperability for Microwave Access (WiMAX), High Speed Packet Access (HSPA), etc. The communication links may transmit electrical, electromagnetic or optical signals, which carry digital data streams, or analog signals representing various types of information. In one embodiment, such as when the gaming system device 124 comprises a gaming machine 125, the gaming system device 124 may include a master gaming controller, which controls the functions of game operation. The communication interface may be associated with the master gaming controller, permitting data to be transmitted between the game server 126 and the master gaming controller.

In one embodiment, the gaming system/environment 122 may include a player tracking system, which includes at least one player-tracking server 128. The player-tracking server 128 may also comprise a computing device including a processor and a memory. The player-tracking server 128 may be adapted to perform player-tracking functions. For example, the player-tracking server 128 may store information regarding the identities of players and information regarding the game play of those players. This information may include time of play, coin in/coin out or other monetary transaction data, and in an arrangement where players are awarded points based on play, a player's point total. Once again, the player tracking system includes a network comprising a communication link provided between the player-tracking server 128 and one or more of the gaming system devices 124 having a player-tracking function or other components of the gaming system/environment 122 associated with the system. In one embodiment, such as where the gaming system device 124 comprises a gaming machine, the device may include a management interface board, which controls a card reader. The management interface board may be arranged to receive data from the master gaming controller of the gaming system device 124. A communication interface is associated with the management interface board, permitting data to be transmitted between the player-tracking server 128 and the management interface board.

In the case of table games, a card reader 129 may be associated with the table (e.g., the card reader located on or near the table game). Players may utilize the card reader to identify themselves. Information regarding play of the table game may be input through an input device by a dealer, coin counter or the like, and this information may be transmitted to the player-tracking server 128.

In one embodiment, the gaming system/environment 122 may include an accounting system, which includes at least one accounting server 130. The accounting server 130 may comprise a computing device including a processor and a memory. The accounting server 130 is preferably adapted to perform financial related functions, such as track financial transactions such as bets and payouts, and perform reconciliations with monies collected from the gaming system devices 124, such as gaming machines 125 and table games 127. The accounting server 130 may be associated with a wide variety of devices, including individual gaming system devices 124, mobile devices 131, and other servers. Once again, a communication link may be provided between the accounting server 130 and each device with which communication is desired.

In one embodiment, the gaming system/environment 122 may include a progressive award system, which includes at least one progressive server 132. The progressive server 132 may comprise a computing device including a processor and a memory. The progressive server 132 may be designed to generate progressive award information. In one arrangement, the progressive server 132 may obtain information regarding amounts bet at specific gaming system devices 124, such as gaming machines 125 or table games 127. Utilizing this information, a progressive jackpot award amount may be generated and updated using a specified protocol. The information may be transmitted to one or more displays 134 associated with participating gaming system devices 124. Once again, a communication link is preferably provided between the progressive server 132 and each device with which communication is desired. For example, a link may be provided between the progressive server 132 and accounting server 130 for providing payout information to the accounting server 130. The accounting server 130 also reads the paid amounts from the electronic gaming machines 125 as well and makes sure the paid amounts match what the progressive server claimed the paid amounts should have been. If the paid amounts do not match, then the accounting server 130 may raise a flag for further investigation by casino staff or regulators.

A physical and/or virtual information host 136 is associated with or comprises a portion of the gaming system/environment 122. In one embodiment, the host 136 comprises a computing device, which includes a processor, memory and a display. The virtual information host 136 may be one or more devices separate from devices performing other functions of the system/environment 122, or may be integrated with existing devices. The virtual information host 136 may be designed and adapted to perform functions relating to acquiring, managing, rendering, generating and/or displaying real-time and/or non real-time casino gaming system or “gaming environment” graphical information and information regarding one or more components of the gaming system or environment. Such functionality may also include the generation of at least one graphical user interface on at least one mobile device (e.g., mobile device 131), which is configured or designed to graphically display information (e.g., real-time casino information) relating to selected aspects of casino activity. Also, different graphical user interfaces may be displayed on an external application (e.g., the gaming host application and/or selected mobile gaming application) of a computer, smart phone, and/or on any type of mobile device 131. In one embodiment, bi-directional communication channels 121 are provided for direct, two-way communication between the host 136 and at least one game server 126 and at least one player-tracking server 128, and/or any other device with which communication is desired.

As illustrated in the example of FIG. 1, gaming system/environment 122 may also include one or more of the mobile devices 131 configured or designed to communicate, via one or more wireless links 111, with various components of the gaming environment 100 such as, for example: information systems (e.g., virtual information host 136); player tracking systems; accounting systems; employee management systems; location positioning systems (e.g., GPS system 133); game servers; surveillance systems; security systems; communication systems; gaming systems (e.g., gaming machines 125, game table devices 127, other mobile devices 131, etc.); etc.

It should be noted that, during an actual implementation of the functionality disclosed herein, players may use the mobile devices 131 (which also may be referred to as the Portable Electronic Devices (PEDs)) to initiate funding transfers, and the mobile devices 131 may use a variety of communication protocols such as near field communication (NFC), Bluetooth, and/or other wireless communications to transfer funds to and from the EGM. The funds of the player may come from any type of financial institution (e.g., a bank) or a player wagering account of one or more gaming venues, and the funds of the player may also be stored on the mobile devices 131 as a virtual ticket. In one embodiment, the wireless communication may communicate directly with the processing unit on a particular and identified EGM. The EGM may further be configured with a software and/or hardware device that communicates with the mobile devices 131. The EGM may contain a device that communicates with the payment acceptor (e.g., a bill acceptor or printer) to simulate bills and tickets. The EGM may have a device (software and/or hardware) that communicates with a back end host that ultimately uses slot account system (SAS) or game-to-system (G2S) to move the money to and from the particular and identified EGM. This configuration allows all of EGMs to be retrofitted for mobile payments.

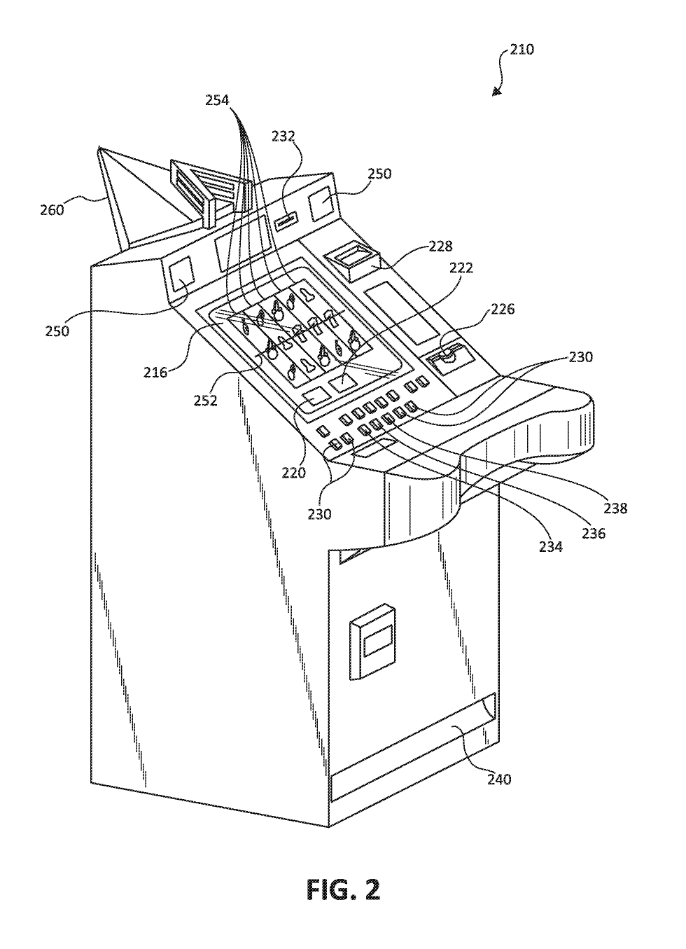

FIG. 2 is a perspective view of one embodiment 210 of a slot machine, EGM, or gaming device suitable for use in the previously depicted system of FIG. 1, in which aspects of the present disclosure may be realized. FIG. 2 represents a base gaming device 210 that can be employed in the shared display system or the gaming system of the present disclosure. FIG. 2 illustrates features common to each of the gaming devices. In one embodiment, gaming device 210 has a support structure, housing or cabinet, which provides support for a plurality of displays, inputs, controls and other features of a conventional gaming machine. In the illustrated embodiment, the player plays gaming device 210 while sitting, however, the gaming device is alternatively configured so that a player can operate it while standing or sitting. The illustrated gaming device 210 is positioned on the floor but can be positioned alternatively (i) on a base or stand, (ii) as a pub-style table-top game (e.g., where the participant gaming devices are located remotely from the shared wheel as discussed below), (iii) as a stand-alone gaming device on the floor of a casino with other stand-alone gaming devices, which the player operates while standing or sitting (e.g., where the participant gaming devices are located remotely from the shared wheel as discussed below), or (iv) in any other suitable manner. The gaming device 210 can be constructed with varying cabinet and display configurations. Also, referring to an embodiment for the electronic configuration of gaming device 210, each gaming device may include the components described below.

In one embodiment, each gaming device 210 randomly generates awards and/or other game outcomes based on probability data. That is, each award or other game outcome is associated with a probability and each gaming device generates the award or other game outcome to be provided to the player based on the associated probabilities. Since each gaming device 210 generates outcomes randomly or based upon a probability calculation, there is no certainty that the gaming device 210 will provide the player with any specific award or other game outcome.

In another embodiment, as discussed in more detail below, each gaming device 210 employs a predetermined or finite set or pool of awards, progressive awards, prizes or other game outcomes. As each award or other game outcome is provided to the player, the gaming device 210 removes the provided award or other game outcome from the predetermined set or pool. Once removed from the set or pool, the specific provided award or other game outcome cannot be provided to the player again. The gaming device 210 provides players with all of the available awards or other game outcomes over the course of the play cycle and guarantees a designated amount of actual wins and losses.

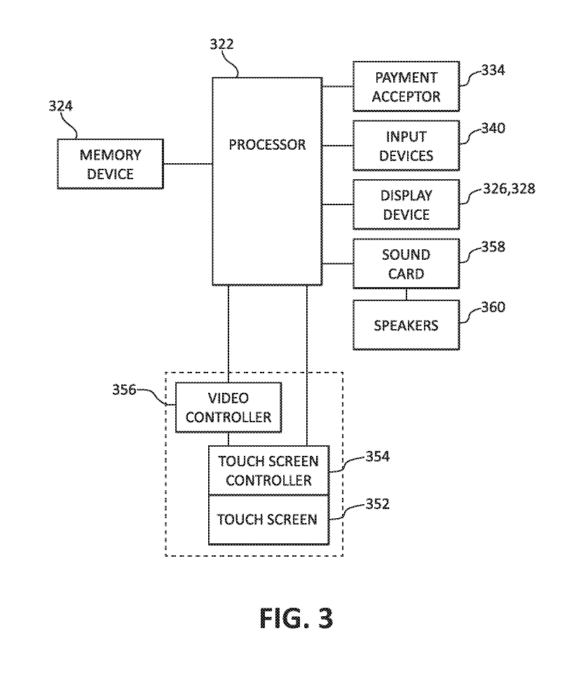

As seen in FIG. 2, the gaming device 210 includes a credit display 220 that displays a player's current number of credits, cash, account balance or the equivalent. In one embodiment, gaming device 210 includes a bet display 222 that displays a player's amount wagered. As illustrated in FIG. 3, in one embodiment, each gaming device 210 includes at least one payment acceptor 334 (FIG. 3) that communicates with processor 322 (FIG. 3).

As seen in FIG. 2, the payment acceptor 334 (FIG. 3) in one embodiment includes a coin slot 226, where the player inserts coins or tokens, and a ticket, note or bill acceptor 228, where the player inserts a bar-coded ticket, note, or cash. In one embodiment, a player-tracking card, credit card, debit card or data card reader/validator 232 is also provided for accepting any of those or other types of cards.

In one embodiment, a player inserts an identification card into card reader 232 of gaming device 210. The identification card can be a smart card having a programmed microchip or a magnetic strip coded with a player's identification, credit totals and other relevant information. In one embodiment, money may be transferred to gaming device 210 through an electronic fund transfer and card reader 232 using the player's credit, debit or smart card. When a player funds gaming device 210, processor 322 (FIG. 3) determines the amount of funds entered and the corresponding amount is shown on the credit display or other suitable display as described above. In one embodiment, after appropriate funding of gaming device 210, the player presses a play button 234 or pull arm (not illustrated) to start any primary game or sequence of events. In one embodiment, upon appropriate funding, gaming device 210 begins game play automatically. In another embodiment, the player needs to actuate or activate one of the play buttons to initiate play of gaming device 210.

As shown in FIG. 2, a bet one button 236 is provided. The player places a bet by pushing bet one button 236. The player increases the player's wager by one credit each time the player pushes bet one button 236. When the player pushes the bet one button 236, the number of credits shown in the credit display 220 decreases by one, and the number of credits shown in the bet display 222 increases by one. A max bet max button (not shown) can also be provided, which enables the player to bet the maximum wager (e.g., max lines and max wager per line). Gaming device 210 may include other suitable wager buttons 230, such as a max bet button, a repeat bet button, one or more select paylines buttons and one or more select wager per payline buttons.

In one embodiment, a cash out button 238 is provided. The player presses cash out button 238 and cashes out to receive a cash payment or other suitable form of payment corresponding to the number of remaining credits. The player can receive coins or tokens in a coin payout tray 240 or a ticket or credit slip, which are redeemable by a cashier or funded to the player's electronically recordable identification card. Each gaming device 210 also includes one or a plurality of communication ports for enabling communication of a processor with one or more external peripherals, such as external video sources, expansion buses, expansion games or other displays, an SCSI port, or a key pad.

In one embodiment of FIG. 2, in combination with in FIG. 3, a touch screen 352 (FIG. 3) is provided in one embodiment and operates with a touch screen controller 354, processor 322 (FIG. 3) and display device 326, 328 (FIG. 3). Touch screen 352 (FIG. 3) and the touch screen controller 354 are also connected to a video controller 356. The player touches touch screen 352 at appropriate places to input decisions and signals into processor 322 of gaming device 210. Also, each gaming device 210 may include a sound generating device controlled by one or more sound cards 358, which function in conjunction with processor 322 (FIG. 3). In one embodiment, the sound generating device includes at least one speaker 250 or other sound generating hardware and/or software for generating sounds, such as playing music for the primary and/or secondary game or for other modes of the gaming device, such as an attract mode. In one embodiment, each gaming device 210 provides dynamic sounds coupled with attractive multimedia images displayed on display device 216 to provide an audio-visual representation or to otherwise display full-motion video with sound to attract players to gaming device 210. During idle periods, the gaming device 210 displays a sequence of audio and/or visual attraction messages to attract potential players to gaming device 210. The videos in one embodiment are customized to provide information concerning the shared display of the present disclosure as discussed below.

In one embodiment, gaming device 210 includes a camera in communication with a processor, which is positioned to acquire an image of a player playing gaming device 210 and/or the surrounding area of gaming device 210. In one embodiment, the camera may be configured to selectively acquire still or moving (e.g., video) images and may be configured to acquire the images in either an analog, digital or other suitable format. Display device 216 may be configured to display the image acquired by the camera as well as display the visible manifestation of the game in split screen or picture-in-picture fashion. For example, the camera may acquire an image of the player and that image can be incorporated into the primary and/or secondary game as a game image, symbol or indicia.

In one embodiment, as illustrated in FIG. 2, a base or primary game includes a slot game with one or more paylines 252. Paylines 252 may be horizontal, vertical, circular, diagonal, angled or any combination thereof. For a slot game, gaming device 210 displays at least one reel and preferably a plurality of reels 254, such as three to five reels, in either electromechanical form with mechanical rotating reels or in video form with simulated reels and movement thereof. Each reel 254 displays a plurality of indicia such as bells, hearts, fruits, numbers, letters, bars or other images, which preferably correspond to a theme associated with the gaming device. With a slot game, gaming device 210 awards prizes when reels 254 stop spinning and display a winning or paying symbol or combination of symbols on an active payline 252.

In one embodiment, each gaming device 210 includes indicators 260. Indicators 260 reside on the top of each gaming device 210 and point to or indicate one of the awards or outcomes on top of a shared display (not shown) when the shared display stops spinning to reveal randomly or otherwise generated results or outcomes. Indicators 260 may illuminate differently at different times or states for the gaming device 210. The illumination of the indicator 260 in one embodiment depends upon whether the gaming device 210 is playing a base game, is in a state in which the player is eligible to play the shared display bonus, is in a state in which the player has committed to play the shared display bonus or is in a state in which the player has declined to play a particular upcoming shared display bonus, as well as other states discussed below.

It should be noted that all of aforementioned functionality of gaming device 210 may be provided, or served, by the gaming device 210 to the one or more mobile devices 131 through the one or more communications networks, and thereby presented for display on the one or more mobile devices 131. To wit, the bet one button 236, credit display 220, bet display 222, wager buttons 230, reels 254, etc. may be implemented as “buttons” or “windows” in an interactive graphical user interface (GUI) through one or more applications (e.g., the gaming host application and/or the selected mobile gaming application) executing on the one or more mobile devices 131, where the one or more applications are processed through to the one or more mobile devices 131 by the gaming device 210.

FIG. 3 is a block diagram illustrating an electronic configuration for use in the gaming device of FIG. 2, here again in which aspects of the present disclosure may be realized. In the embodiment illustrated in FIG. 3, the player station may include at least one processor 322, such as a microprocessor, a microcontroller-based platform, a suitable integrated circuit or one or more ASICs. The processor 322 is in communication with or operable to access or to exchange signals with at least one data storage or memory device 324. In one embodiment, the processor 322 and the memory device 324 reside within the cabinet of the player station. The memory device 324 stores program code and instructions, executable by the processor 322, to control the player station. The memory device 324 also stores other data such as image data, event data, player input data, random or pseudo-random number generators, pay-table data or information and applicable game rules that relate to the play of the player station. In one embodiment, the memory device 324 includes random access memory (RAM), which can include non-volatile RAM (NVRAM), magnetic RAM (MRAM), ferroelectric RAM (FeRAM) and other forms as commonly understood in the gaming industry. In one embodiment, the memory device 324 includes read only memory (ROM). In one embodiment, the memory device 324 includes flash memory and/or EEPROM. Any other suitable magnetic, optical and/or semiconductor memory may operate in conjunction with the player station and gaming system disclosed herein.

In one embodiment, part or all of the program code and/or operating data described above can be stored in a detachable or removable memory device, including, but not limited to, a suitable cartridge, disk, CD ROM, DVD or USB memory device. In other embodiments, part or all of the program code and/or operating data described above can be downloaded to the memory device through a suitable network.

In one embodiment, an operator or a player can use such a removable memory device in a desktop computer, a laptop personal computer, a personal digital assistant (PDA), portable computing device, or other computerized platform to implement the present disclosure. In one embodiment, the gaming system is operable over a wireless network, such as part of a wireless gaming system. In this embodiment, the player station may be a hand-held device, a mobile device or any other suitable wireless device that enables a player to play any suitable game at a variety of different locations. It should be appreciated that a player station as disclosed herein may be a device (e.g., the EGM) that has obtained approval from a regulatory gaming commission or a device that has not obtained approval from a regulatory gaming commission. It should be appreciated that the processor and memory device may be collectively referred to herein as a “computer” or “controller.”

In one embodiment, a background play feature may be available where a player, who may be sitting at the lounge and/or at the bar with friends (at the casino) may be playing a machine from the floor by remote via the external application(s) (e.g., via the one or more mobile devices 131). The player may substitute into the same game he wanted from a Gaming Vendor online game and play, or backend the actual game though a venue network. The game may be bankrolled by the venue the player was inside. If the player was to win the player could collect from that venue where the player was located, and/or instead of “reserving” a machine he could continue the game with an auto play during a period of time the player took a break/recess. In one embodiment, a team game may be played by a group of players (e.g., a group of 3 or 4 players) and the group of players may watch and/or play the same game on each player's individual mobile device (e.g., a computer, tablet, and/or smart phone). Similarly, as described above, the team game may be played by a group of players from a remote location (e.g., bar, lounge, casino, home, office, restaurant, etc.). In one embodiment, the team game may be played by a group of players and the group of players may share credit inputs and wins. In one embodiment, the team game may be played by the group of players and the group of players may sell off and/or share double up options and/or credits to other team players of the group.

In one embodiment, as mentioned above and seen in FIG. 3, one input device is a touch screen 352 coupled with a touch screen controller 354, or some other touch-sensitive display overlay to allow for player interaction with the images on the display. The touch screen and the touch screen controller are connected to a video controller 356. A player can make decisions and input signals into the player station by touching the touch screen at the appropriate places. One such input device is a conventional touch screen button panel. In another embodiment, a plurality or each of the display segments is a touch screen 352 coupled with a touch screen controller 354 or some other touch-sensitive display overlay to allow for player interaction with the images on the display segments. The touch screens 352 and the touch screen controllers 354 are connected to a video controller. The player station may further include a plurality of communication ports for enabling communication of the processor with external peripherals, such as external video sources, expansion buses, game or other displays, an SCSI port, or a key pad. In one embodiment, at least one payment acceptor 334 (which may communicate with processor 322 for playing a bet,) input devices 340, and display devices 326, 328 are provided.

The player stations, the central controller and the display segments may include serial interfaces and/or Ethernet (e.g., G2S (game-to-system) protocol uses commodity Ethernet equipment and TCP/IP) to connect to specific subsystems or subnets internal and external to the player stations, central controller and the display segments. The serial devices may have electrical interface requirements that differ from the “standard” EIA serial interfaces provided by general-purpose computers. These interfaces may include EIA, EIA, Fiber Optic Serial, optically coupled serial interfaces, current loop style serial interfaces, etc. In addition, to conserve serial interfaces internally in the player station, serial devices may be connected in a shared, daisy-chain fashion where multiple peripheral devices are connected to a single serial channel.

The serial interfaces and/or Ethernet (e.g., G2S (game-to-system) protocol uses commodity Ethernet equipment and TCP/IP) may be used to transmit information using communication protocols that are unique to the gaming industry. For example, SAS is a communication protocol used to transmit information, such as metering information, from a player station to a remote device. Often SAS is used in conjunction with a player tracking system. EGMs may be treated as peripheral devices to a casino communication controller and connected in a shared daisy chain fashion to a single serial interface and/or Ethernet. In both cases, the peripheral devices are preferably assigned device addresses. If so, the serial controller circuitry must implement a method to generate or detect unique device addresses. In one embodiment, security-monitoring circuits detect intrusion into a player station or gaming station by monitoring security switches attached to access doors in a designated area, such as a player station cabinet. In one embodiment, access violations result in suspension of game play and can trigger additional security operations to preserve the current state of game play. These circuits also function when power is off by use of a battery backup. In one embodiment, as seen in FIG. 3, the player station includes a sound generating device controlled by one or more sound cards 358 which function in conjunction with the processor. In one embodiment, the sound generating device includes at least one and preferably a plurality of speakers 360, which may be part of a distributed speaker system, or other sound generating hardware and/or software for generating sounds, such as playing music for the primary and/or secondary game or for other modes of the player station, such as an attract mode. In one embodiment, the player station provides dynamic sounds coupled with attractive multimedia images displayed on one or more of the display devices to provide an audio-visual representation or to otherwise display full-motion video with sound to attract players to the player station. During idle periods, the player station may display a sequence of audio and/or visual attraction messages to attract potential players to the player station. The videos may also be customized for or to provide any appropriate information.

In one embodiment, the gaming system may include a sensor, such as a camera in communication with the processor (and possibly controlled by the processor) that is selectively positioned to acquire an image of a player actively using the player station and/or the surrounding area of the player station. In one embodiment, the camera may be configured to selectively acquire still or moving (e.g., video) images and may be configured to acquire the images in either an analog, digital or other suitable format. The display devices may be configured to display the image acquired by the camera as well as display the visible manifestation of the game in split screen or picture-in-picture fashion. For example, the camera may acquire an image of the player and the processor may incorporate that image into the primary and/or secondary game as a game image, symbol or indicia. In another embodiment, the gaming system includes a wireless transceiver or a camcorder and the display segments are components of or are connected to televisions, satellites, DVD players, digital video recorders and Internet-enabled devices. In one embodiment, the game may be displayed on the central display and replicated on one or more the player stations. In another embodiment, the game is only displayed on the central display and the player station is only used to input decisions or commands in the game. In another embodiment, a primary or base game is displayed on the player station and/or the central display and one or more bonus games are displayed on the central display only. In one embodiment, the player stations provide other information to a player, such as the win/loss history of that certain games or the win/loss history of that player. It should be appreciated that the central display and the player stations may work together with a central controller or a plurality of servers to provide the games to the player in any suitable manner.

Mobile Wallet with Unlockable Capabilities

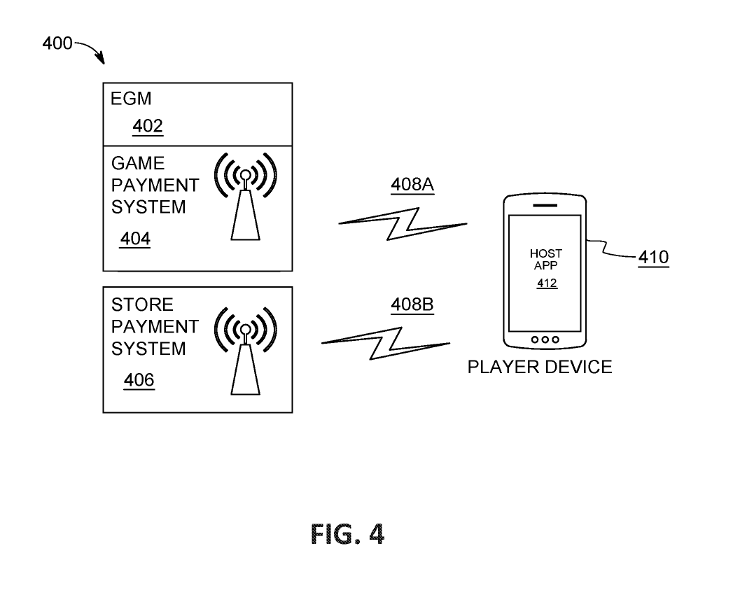

Having described one or more gaming establishments and/or EGM architectures, turning now to FIG. 4 communications between a portable electronic device and multiple payment systems within a gaming establishment 400 are illustrated.

Consider, for illustration purposes, that an EGM 402 may itself provide, or facilitate providing to the portable electronic device 410, at least two mobile services: a money transfer service and game play functionality. The money transfer service may enable a player to cash-in and cash-out using the portable electronic device 410 and a mobile application, such as, gaming establishment application 412. In other words, a player may, in some embodiments, use the portable electronic device 410 and the EGM 402 interchangeably such that accounting functions (e.g., login and money transfer functionality) may, for example, be performed on the gaming establishment application 412 of the portable electronic device 410, and subsequently the player may then initiate a game application on either the portable electronic device 410 or on the EGM 402 itself, and vice versa.

In one aspect, the gaming establishment application 412 may be associated with a slot machine interface board (SMIB) (or otherwise a “game payment system” 404) of the EGM 402 such that the gaming establishment application 412 may be operated on or by the SMIB and connected to the portable electronic device 410 via a wired and/or wireless connection, such as wireless connection 408A and/or 408B to fund one or more wagers associated with gameplay of the EGM 402. The gaming establishment application 412 may be branded or associated with a gaming host (e.g., a casino or gaming establishment), identifying a specific property, brand, or slogan. Gaming establishments may brand the gaming establishment application 412 in an effort to distinguish their mobile application as genuine and secure, particularly since the gaming establishment may manage funds transferred to and from their respective property application. Again, the gaming establishment application 412 may communicate with the EGM 402 game payment system 404 or an alternative communications module within the EGM 402 via the wired and/or wireless connections 408A, 408B of which may comprise communication protocols such as Wi-Fi™, Bluetooth™, Radio Frequency (RF), Infrared, third generation partnership project (3GPP) long term evolution (LTE), Worldwide interoperability for Microwave Access (WiMAX), High Speed Packet Access (HSPA), or other wireless communication standards.

In one embodiment, once the player has been authorized by input of the player login credentials to the gaming establishment application 412, the player may then be automatically transferred to an interface such as an account “home” screen, through which the player may then complete the desired monetary or account functions associated with the player's account with the gaming establishment. The monetary or account functions may include performing a cash-in cash-out operation, establishing a transferring of the winnings, funding a bet associated with gameplay, establishing a credit balance to fund the bet associated with the gameplay, changing and/or resetting one or more of the login credentials of the user/player, providing player loyalty account information, making a purchase for goods or services, or a combination thereof.

Also depicted in FIG. 4 is the portable electronic device 410 in communication via one or more wireless communication networks 408A, 408B to alternative payment systems within the gaming establishment, such as the store payment system 406. Using the gaming establishment application 412 and the mobile wallet functionality therein, the player may use the portable electronic device 410 initiate and complete payments to the store payment system 406 using funds virtually stored in the mobile wallet of the gaming establishment application 412. The store payment system 406 may, again, comprise any payment system within the gaming establishment which is not directly related to wager gaming. That is, the store payment system 406 may comprise a payment system at a gift or merchandise shop, restaurant or bar, ticket counter, hotel front desk, etc. within the gaming establishment. The portable electronic device 410 through the gaming establishment application 412 may communicate to such payment systems via the one or more wireless communication networks 408A, 408B using any of the communications protocols listed previously.

The mobile wallet of the gaming establishment application 412 may store data relating to the player, including personal data, gaming establishment account or casino data, financial data, loyalty data, etc. The financial data may comprise banking account information external to the gaming establishment (e.g., banking institution account and routing numbers, credit card information, debit card information, etc.) and/or a non-monetary credit balance the player has established with the gaming establishment through funding associated with the player's external banking information. The personal data may include a name, address, telephone number, driver's license number, email address, written signature (i.e., the player's written signature on documents), social security number (or a portion thereof for identification verification purposes), or any other personal data relating to the player.

In various embodiments described herein, the mobile wallet of the gaming establishment application 412 includes “tiered” or unlockable (or lockable) capabilities which are controlled by various aspects of the mobile wallet. Selecting or de-selecting these aspects may enable or disable certain capabilities provided by the mobile wallet of the gaming establishment application 412. For example, in one aspect, the mobile wallet may be unlocked to allow the funding of one or more wagers for gaming via the communications with the game payment system 404 of the EGM 402. That is, a selection may be performed within the gaming establishment application 412 and within the mobile wallet functionality therein to “lock” or “unlock” the funding of wagers for gameplay via the player's stored credit balance or other financial information, such that if this selection is locked, the mobile wallet will not provide mobile payments for the funding of wagers when communicating with the game payment system 404 of the EGM 402. Conversely, if wager funding is unlocked, the mobile wallet of the gaming establishment application 412 will allow the EGM 402 to accept payment for the funding of one or more wagers for gameplay via the game payment system 404. Moreover, limits on wager funding may be imposed such that the mobile wallet will only allow the funding of the one or more wagers to the EGM 402 over the game payment system 404 up to a predetermined amount as selected (by a player or as automatically set by the gaming establishment) within the mobile wallet of the gaming establishment application 412.

In another example, a selection may be made in the gaming establishment application 412 to lock or unlock funding of purchases made at one or more stores, gift shops, restaurants, hotels, etc. of the gaming establishment. In other words, the mobile wallet of the gaming establishment application 412 may allow selections to lock or unlock payments funded to the store payment system 406 such that if this selection is locked, purchases will not be allowed to be initiated from the mobile wallet (regardless of what the credit balance is in the mobile wallet) to one or more stores, gift shops, restaurants, etc. within the gaming establishment. It is important to note that these selections may be employed simultaneously and may be of any level of granularity. That is, wager funding by the mobile wallet to the game payment system 404 of the EGM 402 may be locked while concurrently payments conducted elsewhere in the gaming establishment within the scope of the store payment system 406 may be unlocked, and vice versa. Further, wager funding to one particular EGM 402 may be locked while concurrently wager funding to an alternative EGM may be concurrently unlocked, or funding to one particular store payment system 406 may be unlocked (such as a restaurant payment system) while an alternative store payment system (such as a merchandise shop) may be concurrently locked, and vice versa.

In a further example and in an additional aspect, the mobile wallet may not allow (lock) the funding of the one or more wagers to the game payment system 404 of the EGM 402 upon detecting that the player has not yet entered identifying information, such as the personal information discussed previously. Upon entering the identifying personal information, or predetermined portions thereof (e.g., name, address, and driver's license number, etc.), the mobile wallet may automatically unlock or allow the player to make the selection to unlock the funding of the one or more wagers to the game payment system 404 of the EGM 402, for funding wagering gameplay.

In yet another example and further aspect, the unlocking capabilities of the mobile wallet of the gaming establishment application 412 may be enabled by the collection of a digital signature of the player. Prior to obtaining the digital signature, funding the one or more wagers through the game payment system 404 may be locked, or, in other embodiments, upon securing the digital signature identifying the player, a deposit or withdrawal limit of the mobile wallet may be increased from a previous limit imposed (e.g., by the gaming establishment and/or a regulatory body) when no digital signature is identified. The authentication for the digital signature of the player may be provided by several means. For example, the player's portable electronic device 410 may incorporate a message authenticating the device to the mobile wallet by way of a player entering certain identifying information, providing a biometric (fingerprint, etc.) or password identifier, confirming bank account information, or a host of other means by which the player may be identified.

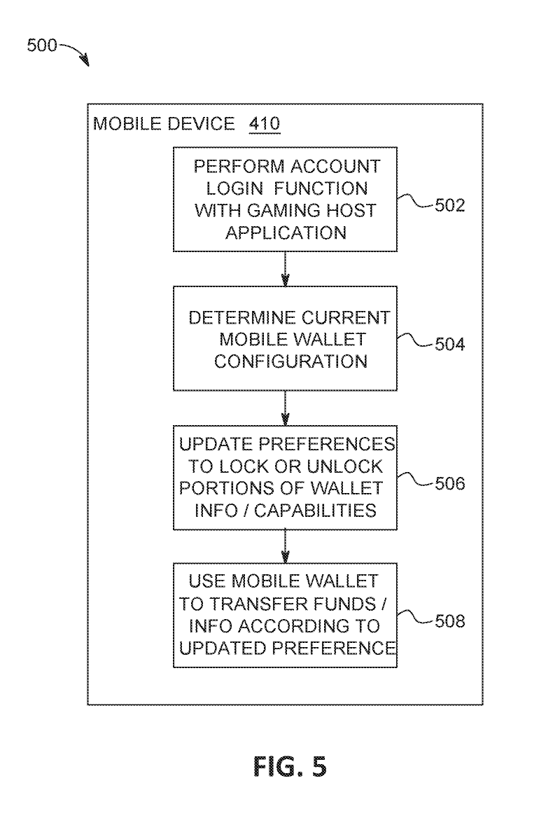

Turning now to FIG. 5, a flowchart illustrating an exemplary method 500 for providing tiered mobile wallet capabilities in a gaming system is depicted. The method 500 may be implemented in various environments described in FIGS. 1-4.

In operation, the method 500 may include one or more of the following actions. An account login function or association may be performed on the portable electronic device 410 using a GUI interface provided by the gaming establishment application 412, as in block 502. A current mobile wallet configuration of the gaming establishment application 412 may be determined (i.e., which capabilities are locked and which are unlocked), as in block 504. Preferences may be updated as to which portions of the mobile wallet to lock and unlock, and various settings preferences thereof, as in block 506. That is, certain capabilities as to which payment systems the mobile wallet is locked to disallow interface with, and unlocked to allow interface with (including wagering and other limits, such as a spending limit at a gift shop) may be set within the gaming establishment application 412. The mobile wallet of the gaming establishment application 412 is then updated to be used in conjunction with the associated selections by the mobile device 410 for performing financial and other data transfers with other interfaces within the gaming establishment, as in block 508.

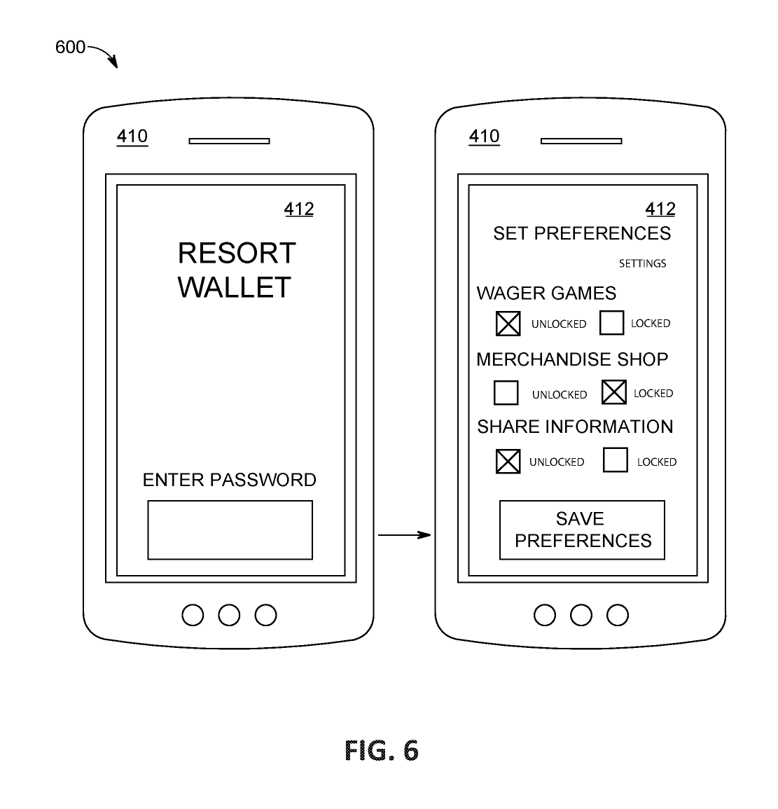

FIG. 6 is a block diagram illustrating a graphical user interface (GUI) of unlocking capabilities 600 of the gaming establishment application 412 for use on the portable electronic device 410. As depicted in FIG. 6, the gaming establishment application 412 may incorporate a first GUI screen for entering a password or other identifying information (e.g., biometric data including fingerprints, face identification, iris identification, etc.). Upon entering the identifying information by the player, at least some portion of the gaming establishment application 412 may include preferences as to the locking and unlocking capabilities of the mobile wallet therein. As aforementioned, funding wagering games may be unlocked concurrently with locking the funding of transactions at alternative payment systems within the gaming establishment (or vise versa). Moreover, further GUI screens (not shown) may also be displayed as to set spending limits, time limits, etc. for each of the associated capabilities. Further, by way of example only, the GUI may also include selections for sharing player information, identifying information, loyalty information, tracking information, etc. with the wagering games, payment systems, and gaming establishment application 412 in general, as implemented and allowed by the particular gaming establishment.

It should be noted that the examples of the described embodiments have disclosed the unlocking and locking capabilities of the mobile wallet of the gaming establishment application 412 with reference to the player making such selections within the mobile wallet of the gaming establishment application 412. However, in an actual implementation, many variations exist, and no variation may be particularly more exemplary than others. For example, in one embodiment, the player may see a GUI display as illustrated in FIG. 6 and may be allowed to make such selections as to which capabilities of the mobile wallet are locked and unlocked. That is, the player may choose whether to unlock or lock the funding or wagers for gaming, the funding of transactions performed at other payment systems (e.g., the restaurants, gift shops, etc.), and the limits imposed thereon through the manual selection of each capability presented in the gaming establishment application 412 on the GUI of the mobile device 410.

In another example, the gaming establishment may set and un-set the locking capabilities of the mobile wallet such that the player does not see the GUI selection screen of FIG. 6 and thus does not have control over which capabilities are unlocked and which capabilities are locked. This may be implemented by designing the gaming establishment application 412 with specific code directed towards a specific policy of the particular gaming establishment such that each stated capability as discussed previously is either automatically implemented or may be implemented per an administrator of the gaming establishment.

In still another example, a combination of the aforementioned techniques may be implemented where the capabilities of the mobile wallet are implemented such that the player has a certain amount of control over certain capabilities, yet cannot control whether other capabilities of the wallet are locked or unlocked. This may include displaying those capabilities the player is allowed to control in the mobile wallet of the gaming establishment application 412 and not displaying those capabilities the player is not able to control (i.e., that the gaming establishment itself controls). Alternatively, the mobile wallet of the gaming establishment application 412 may display all lockable capabilities yet “grey out” (such that they may not be selected) those selections which the player is not allowed or authorized to make or control. Consider the example discussed above where the mobile wallet does not allow (locks) the funding of the one or more wagers to the game payment system 404 of the EGM 402 upon detecting that the player has not yet entered identifying information, or sets a deposit or withdrawal limit which may be increased upon detecting a digital signature has been secured. The GUI of the gaming establishment application 412 may grey out such selections until the player inputs the required information, or may prompt the user to enter the identifying information to allow (or show) the selections for changing whether the wager funding or increasing the deposit and withdrawal limit.

In some embodiments, the gaming establishment may control at least a portion of the selectable capabilities of the mobile wallet in the gaming establishment application 412 in accordance with regulatory conditions set by governing bodies. For example, in some jurisdictions, a player is not authorized by laws and statutes tied to gaming commissions to fund a wager on a gaming machine unless certain identifying information is obtained from the player. For this reason, the mobile wallet may not allow the player to unlock the capability of the mobile wallet to fund a game wager until they have entered certain identifying information into the gaming establishment application 412. In some embodiments, the selection of various capabilities of the mobile wallet (e.g., funding the game wager, funding the transaction at the gift shop/restaurant/hotel, transferring money from their banking institution to establish the credit balance, withdraw money from the credit balance for transfer to their banking institution, etc.) may be tied to contextual attributes detected by the personal electronic device 410. That is, certain contextual attributes such as a time of day, day of the week, a geolocation of the player as identified by a GPS of the personal electronic device 410, etc. may be used to implement certain automatic restrictions or locks on the capabilities of the mobile wallet. For example, certain gaming jurisdictions do not allow gaming on certain days of the week (e.g., Sunday). Therefore, based on the geolocation of the personal electronic device 410 (and thereby the player) and/or the day of the week, the capability of the mobile wallet to fund the one or more wagers to a given gaming machine may be locked while certain alternative capabilities of the mobile wallet may remain unlocked (e.g., using the mobile wallet to conduct a transaction at a resident restaurant). Many variations exist while staying within the spirit and scope of the functionality described herein.

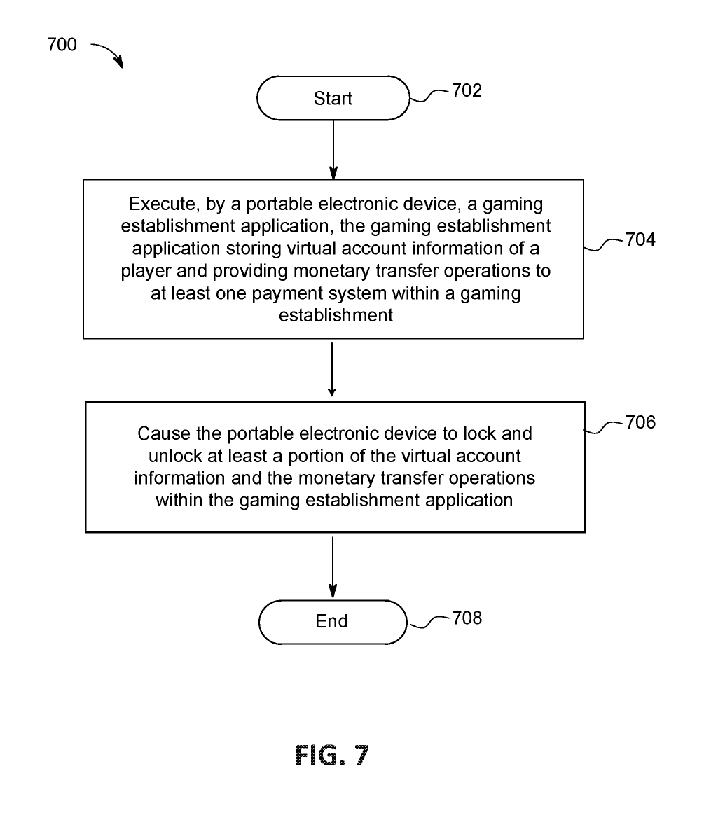

FIG. 7 is a flowchart illustrating an additional exemplary method 700 for providing tiered mobile wallet capabilities in a gaming system. The functionality 700 may start in block 702. The portable electronic device 410 may execute the gaming establishment application 412, the gaming establishment application 412 storing virtual account information of a player and providing monetary transfer operations to at least one payment system within a gaming establishment, as in block 704. The portable electronic device 410 may lock and unlock at least a portion of the virtual account information and the monetary transfer operations within the gaming establishment application 412 such that, upon locking at least the portion of the virtual account information and the monetary transfer operations, at least one of the monetary transfer operations to the at least one payment system within the gaming establishment is disabled, as in block 706. The method 700 may end in block 708.

In one aspect, in conjunction with and/or as part of at least one block of FIG. 7, the functionality of the method 700 may include one or more of the following.

In one aspect, upon unlocking at least the portion of the virtual account information and the monetary transfer operations, the at least one of the monetary transfer operations to the at least one payment system within the gaming establishment is enabled or re-enabled.

In one aspect, the virtual account information comprises at least one selected from a list comprising a credit balance, banking information, loyalty and gaming establishment account information, and personal information of the player.

In one aspect, the credit balance is funded from an external source associated with the banking information of the player.

In one aspect, the monetary transfer functions are performed wirelessly upon the portable electronic device establishing a secure connection with the at least one payment system.

In one aspect, the personal information of the player comprises at least one selected from a list comprising a name of the player, an address of the player, a driver's license number of the player, an email address of the player, and a written signature of the player.

In one aspect, a first one of the monetary transfer operations comprises transferring funds from the credit balance held by the gaming establishment application to the at least one payment system of a wagering game within the gaming establishment.

In one aspect, a second one of the monetary transfer operations comprises transferring funds from the credit balance held by the gaming establishment application to the at least one payment system of a store for purchasing merchandise within the gaming establishment.

In one aspect, the unlocking of at least a portion of the virtual account information and the monetary transfer operations further comprises increasing a deposit or withdrawal limit associated with the credit balance of the gaming establishment application upon determining that a digital signature of the player has been secured by the personal electronic device.

In one aspect, the locking and unlocking of at least a portion of the virtual account information and the monetary transfer operations is automatically performed to ensure adherence to gaming regulatory conditions.

In one aspect, the locking and unlocking of at least a portion of the virtual account information and the monetary transfer operations is automatically performed upon determining, by the personal electronic device, that one of a plurality of contextual attributes has been identified.

As aforementioned, the mobile device 410 may comprise a desktop computer, a portable phone (e.g., a “smartphone”), a media player, a personal data organizer, a handheld game platform, a tablet computer, a notebook or portable computer, or any combination of such devices. Additionally, some or all of the aforementioned functionality may be implemented cross-platform between the mobile device 410 and the EGM 402. In other words, when referring to functionality throughout the present disclosure being performed by “the mobile device 410”, this functionality may be equally performed by “the EGM 402” and vice versa.

As will be appreciated by one skilled in the art, aspects of the present disclosure may be embodied as an apparatus, system, method or a computer program product. Accordingly, aspects of the present disclosure may take the form of an entirely hardware embodiment, an entirely software embodiment (including firmware, resident software, micro- code, etc.) or an embodiment combining software and hardware aspects that may all generally be referred to herein as a “circuit,” “module” or “system.”

Aspects of the present disclosure have been described above with reference to flowchart illustrations and/or block diagrams of methods, apparatus, and systems according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks.

These computer program instructions may also be stored in a computer readable storage medium that may direct a computer, other programmable data processing apparatus, or other devices to function in a particular manner, such that the instructions stored in the computer readable storage medium produce an article of manufacture including instructions which implement the function/act specified in the flowcharts and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowcharts and/or block diagram block or blocks.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that may contain, or store a program for use by or in connection with an instruction execution system, apparatus, or device.

The flowcharts and block diagrams in the above figures illustrate the architecture, functionality, and operation of possible implementations of systems, methods and computer program products according to various embodiments of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

What is claimed is:

1. A method for providing tiered mobile wallet capabilities in a gaming system, by a processor, comprising:
executing, by a portable electronic device, a gaming establishment application, the gaming establishment application storing virtual account information of a player and providing monetary transfer operations to at least one payment system within a gaming establishment; and
causing the portable electronic device to lock and unlock at least a portion of the virtual account information and the monetary transfer operations within the gaming establishment application such that, upon locking at least the portion of the virtual account information and the monetary transfer operations, at least one of the monetary transfer operations to the at least one payment system within the gaming establishment is disabled.

2. The method of claim 1, wherein upon unlocking at least the portion of the virtual account information and the monetary transfer operations, the at least one of the monetary transfer operations to the at least one payment system within the gaming establishment is enabled or re-enabled.

3. The method of claim 1, wherein the virtual account information comprises at least one selected from a list comprising a credit balance, banking information, loyalty and gaming establishment account information, and personal information of the player.

4. The method of claim 3, wherein:
the credit balance is funded from an external source associated with the banking information of the player; and
the monetary transfer functions are performed wirelessly upon the portable electronic device establishing a secure connection with the at least one payment system.

5. The method of claim 3, wherein the personal information of the player comprises at least one selected from a list comprising a name of the player, an address of the player, a driver's license number of the player, an email address of the player, and a written signature of the player.

6. The method of claim 3, wherein a first one of the monetary transfer operations comprises transferring funds from the credit balance held by the gaming establishment application to the at least one payment system of a wagering game within the gaming establishment.

7. The method of claim 3, wherein a second one of the monetary transfer operations comprises transferring funds from the credit balance held by the gaming establishment application to the at least one payment system of a store for purchasing merchandise within the gaming establishment.

8. The method of claim 3, wherein the unlocking of at least a portion of the virtual account information and the monetary transfer operations further comprises increasing a deposit or withdrawal limit associated with the credit balance of the gaming establishment application upon determining that a digital signature of the player has been secured by the personal electronic device.

9. The method of claim 1, further comprising automatically performing the locking and unlocking of at least a portion of the virtual account information and the monetary transfer operations to ensure adherence to gaming regulatory conditions.

10. The method of claim 1, further comprising automatically performing the locking and unlocking of at least a portion of the virtual account information and the monetary transfer operations upon determining, by the personal electronic device, that one of a plurality of contextual attributes has been identified.

11. A gaming system providing tiered mobile wallet capabilities, comprising:
a communications network;
at least one payment system in a gaming establishment;
a personal electronic device in communication with the at least one payment system of the gaming establishment, the personal electronic device having a processor and a memory device storing executable instructions which, when executed by the processor, cause the processor to:
execute a gaming establishment application on the personal electronic device, the gaming establishment application storing virtual account information of a player and providing monetary transfer operations to the at least one payment system within a gaming establishment; and
cause the portable electronic device to lock and unlock at least a portion of the virtual account information and the monetary transfer operations within the gaming establishment application such that, upon locking at least the portion of the virtual account information and the monetary transfer operations, at least one of the monetary transfer operations to the at least one payment system within the gaming establishment is disabled.

12. The gaming system of claim 11, wherein when executed by the processor, the instructions cause the processor to enable or re-enable the at least one of the monetary transfer operations to the at least one payment system within the gaming establishment upon unlocking at least the portion of the virtual account information and the monetary transfer operations.

13. The gaming system of claim 11, wherein the virtual account information comprises at least one selected from a list comprising a credit balance, banking information, loyalty and gaming establishment account information, and personal information of the player.

14. The gaming system of claim 13, wherein the credit balance is funded from an external source associated with the banking information of the player; and
the monetary transfer functions are performed wirelessly using the communications network upon the portable electronic device establishing a secure connection with the at least one payment system.

15. The gaming system of claim 13, wherein the personal information of the player comprises at least one selected from a list comprising a name of the player, an address of the player, a driver's license number of the player, an email address of the player, and a written signature of the player.

16. The gaming system of claim 13, wherein when executed by the processor, the instructions cause the processor to, pursuant to performing a first one of the monetary transfer operations, transfer funds from the credit balance held by the gaming establishment application to the at least one payment system of a wagering game within the gaming establishment.

17. The gaming system of claim 13, wherein when executed by the processor, the instructions cause the processor to, pursuant to performing a second one of the monetary transfer operations, transfer funds from the credit balance held by the gaming establishment application to the at least one payment system of a store for purchasing merchandise within the gaming establishment.

18. The gaming system of claim 13, wherein the unlocking of at least a portion of the virtual account information and the monetary transfer operations further comprises executing the instructions to cause the processor to increase a deposit or withdrawal limit associated with the credit balance of the gaming establishment application upon determining that a digital signature of the player has been secured by the personal electronic device.

19. The gaming system of claim 11, wherein when executed by the processor, the instructions cause the processor to automatically perform the locking and unlocking of at least a portion of the virtual account information and the monetary transfer operations to ensure adherence to gaming regulatory conditions.

20. The gaming system of claim 11, wherein when executed by the processor, the instructions cause the processor to automatically perform the locking and unlocking of at least a portion of the virtual account information and the monetary transfer operations upon determining, by the personal electronic device, that one of a plurality of contextual attributes has been identified.
